(19) United States
(12) Patent Application Publication
(10) Pub. No.: US 2026/0087381 A1
(43) Pub. Date: Mar. 26, 2026

(54) SYSTEM AND METHOD FOR VERIFIABLE, ETHICAL ARBITRATION AND IMMUTABLE AUDITING OF AUTONOMOUS DECISIONS USING CONSTRAINED EXECUTION ENVIRONMENTS

(71) Applicant: Richard Joseph Mitchell, TAVARES, FL (US)

(72) Inventor: Richard Joseph Mitchell, TAVARES, FL (US)

(21) Appl. No.: 19/383,681

(22) Filed: Nov. 9, 2025

(51) Int. Cl. G06N 5/022; G06F 21/60

(52) U.S. Cl. CPC G06N 5/022; G06F 21/602

(57) ABSTRACT

A system and method for creating a verifiable, non-repudiable audit log of an autonomous system's ethical decision-making, solving the “black-box” problem for safety-critical applications. The system integrates a Trusted Execution Environment (TEE) with a Hierarchical Constraint Logic Processor (HCLP). The TEE's integrity is verified using a decentralized remote attestation (RA) state measurement incorporating a measurement from an intrinsic Physically Unclonable Function (PUF), which provides a hardware root of trust. The HCLP applies tiered constraints to select a control maneuver with the lowest calculated harm score from a set of potential outcomes. The system generates a novel, verifiable log entry that cryptographically binds the RA state measurement to the calculated harm scores of all rejected control maneuvers. This counterfactual log is immutably anchored into a Cryptographic Audit Log Service using a Merkle Tree, generating a non-repudiable Cryptographic Audit Certificate (CAC) for definitive, post-facto regulatory verification.

### BACKGROUND OF THE INVENTION

### 1. Technical Field

The present disclosure relates generally to confidential computing systems, and more specifically, to systems and methods for achieving verifiable, decentralized trust guarantees for the execution of adaptive, safety-critical decision logic within protected hardware boundaries, utilizing enhanced remote attestation protocols, constraint logic programming, and distributed cryptographic auditing. The invention is particularly applicable to autonomous systems requiring auditable governance of ethical and safety-critical decision-making processes.

### 2. Background Art

The increasing reliance on automated or artificial intelligence (AI) systems, particularly in safety-critical domains such as autonomous vehicle (AV) control, necessitates robust, verifiable trust guarantees. The most significant unresolved technical question in autonomous operation is the “trolley problem”—how an autonomous agent decides between two or more undesirable outcomes when a collision is unavoidable. Regulatory bodies (e.g., FAA, NHTSA) and public acceptance demand that this life-critical decision cannot be an unexplainable “black-box” event; the operator must be able to prove why the machine made the choice it did.

Trusted Execution Environments (TEEs) have emerged as a foundational technology for protecting data and execution integrity. Remote Attestation (RA) is used to verify the integrity and authenticity of applications running within these TEEs. However, current RA designs suffer from significant technical limitations. Existing TEE RA schemes typically employ a centralized trust model, relying on a single provisioned secret key and a centralized verifier. This centralized dependency introduces a brittle point of failure. A technological improvement is required to decentralize this trust framework, for instance, by using intrinsic hardware mechanisms like Physically Unclonable Functions (PUFs) to fortify the Root of Trust (RoT).

Furthermore, traditional decision systems executed within TEEs lack the flexibility needed for sophisticated arbitration, such as dynamically applying tiered ethical rules. Abstract ideas related to constraint satisfaction, such as Hierarchical Constraint Logic Programming (HCLP), exist but have not been effectively integrated into a secure, verifiable hardware structure to solve the technical problem of auditable ethical arbitration.

A related deficiency exists in the auditing process. Even if a secure TEE executes a critical decision, the subsequent logs often lack the cryptographic assurance required for non-repudiation. Prior art logging systems for AI decisions typically record model inputs, intermediate reasoning, and final outputs. However, this is insufficient for a true regulatory audit of an ethical choice, which requires proving why a specific action was chosen over other viable alternatives (a “counterfactual” or “why not” explanation). No existing system provides a cryptographically-bound log that proves, with hardware-level integrity, the specific harm scores of the rejected options.

The critical technical problem solved by the disclosed invention is the inability of current AI systems to provide a verifiable, non-black-box, and immutable record of their counterfactual ethical reasoning process in real-time, due to centralized trust weaknesses, inflexible execution logic, and incomplete audit logs.

### BRIEF SUMMARY OF THE INVENTION

A system and method are disclosed that solve the “black-box” problem by creating a novel, hardware-attested, and non-repudiable audit log of an autonomous system's counterfactual reasoning. The invention provides a specific technical improvement to computing systems that must perform and verifiably audit safety-critical decisions.

The system integrates four key components into a new, non-obvious architecture. First, a Trusted Execution Environment (TEE) provides a hardware-isolated enclave to protect decision logic. Second, this TEE is anchored to a Physically Unclonable Function (PUF), which provides an intrinsic, decentralized hardware Root of Trust (RoT) for a remote attestation (RA) state measurement. This attestation verifiably proves the integrity of the TEE and its logic.

Third, a Hierarchical Constraint Logic Processor (HCLP) executes within the TEE. This processor applies a novel constraint hierarchy comprising “Required Constraints” (non-negotiable physical safety mandates, e.g., vehicle dynamics) and “Preferential Constraints” (tiered ethical mandates, e.g., human life preservation). The HCLP processes multiple potential outcomes (e.g., vehicle maneuvers) to select a single maneuver that satisfies all Required Constraints and has the lowest “harm score” according to the Preferential Constraints.

Crucially, the inventive method configures the system to generate a specific, verifiable log entry that cryptographically binds the hardware attestation (from the PUF/TEE) to the full reasoning of the HCLP. This log entry includes not only the chosen action but also the calculated harm scores of all rejected potential outcomes. This log of counterfactuals is the key technical solution to the “black-box” problem.

Finally, this verifiable log entry is anchored into a tamper-evident Cryptographic Audit Log Service, such as a Merkle Tree, to create a permanent, non-repudiable Cryptographic Audit Certificate (CAC). This CAC allows an auditor to definitively verify who (which hardware), how (which ruleset), and why (which ethical calculation, including the rejected alternatives) a safety-critical decision was made.

### BRIEF DESCRIPTION OF THE SEVERAL VIEWS OF THE DRAWINGS

FIG. 1 is a block diagram illustrating the overall Ethical Governance Engine system architecture (100), demonstrating the interplay between the Trusted Execution Environment (TEE) (110), the Hierarchical Constraint Logic Processor (HCLP) (120), and the Cryptographic Audit Log Service (130).

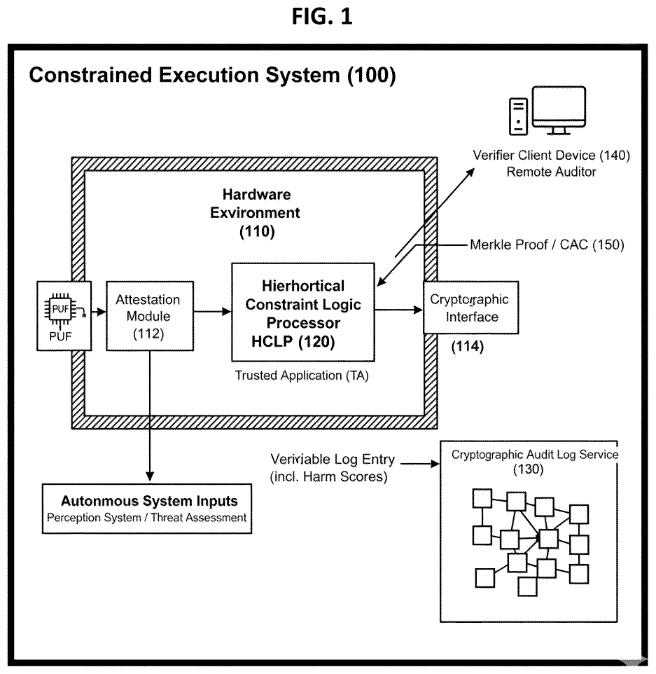

FIG. 2 is a flowchart detailing the decentralized remote attestation (RA) protocol, including PUF-enhanced measurement and decentralized verification.

FIG. 3 is a conceptual diagram illustrating the function of the Hierarchical Constraint Logic Processor (HCLP) (120) and its application of Required (Hard) and Preferential (Ethical) constraints to multiple predicted outcomes.

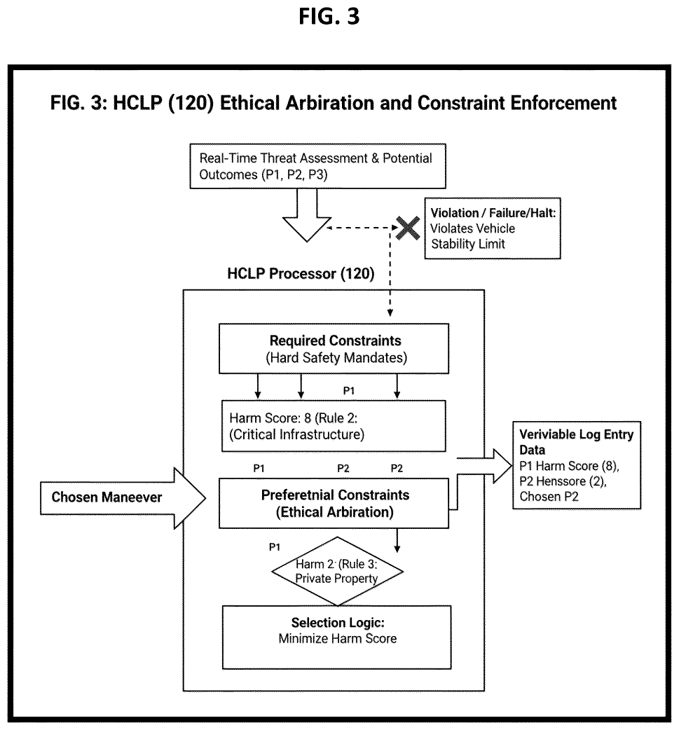

FIG. 4 is a diagram illustrating the process for anchoring verifiable log entries, including rejected outcomes, into a Merkle Tree structure maintained by the Cryptographic Audit Log Service (130), culminating in the generation of the Cryptographic Audit Certificate (CAC) (150).

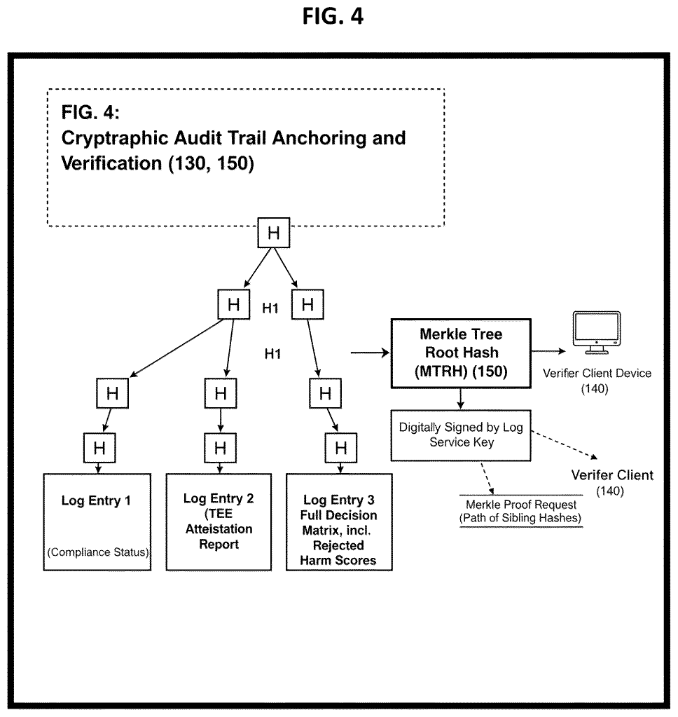

### DETAILED DESCRIPTION OF THE INVENTION

The following detailed description of the embodiments focuses on the implementation of the Ethical Governance Engine (EGE) for Autonomous Systems for the high-value utility of verifiable, ethical arbitration.

### A. System Architecture and Operating Environment

### 1. Confidential Computing Infrastructure (100, 110)

The core structure of the system (100) relies on a processing device configured to establish a Trusted Execution Environment (TEE) (110) within a safety-critical system, such as an autonomous vehicle. The TEE (110) represents a secured, isolated area within the hardware, protected from the Host OS and Hypervisor, analogous to known technologies such as Intel SGX or AMD SEV. The TEE (110) is configured to execute a Trusted Application (TA) (120), which encapsulates the sensitive decision logic of the Ethical Governance Engine (EGE).

The TEE (110) includes an integrated Attestation Module (112) capable of measuring the TEE's current state. This measurement includes hashes of the running code (TA 120), configuration data, and environment parameters.

### 2. Decentralized Trust Components (112, 130)

The disclosed architecture deliberately moves away from centralized trust models. The Attestation Module (112) incorporates an intrinsic Root of Trust (RoT) by using a measurement derived from a Physically Unclonable Function (PUF). The PUF provides a device-specific, cryptographic enhancement to the state measurement, making the resulting attestation report uniquely tied to the physical hardware and resistant to advanced impersonation attacks.

The Cryptographic Audit Log Service (130) is an external component, implemented as a distributed ledger or a certificate transparency log structure. This service acts as a publicly auditable repository for immutable records, providing verifiable integrity and authenticity for the log results. The Log Service (130) communicates with the TEE (110) via a Cryptographic Interface (114) and a remote Verifier Client Device (140).

### 3. Cryptographic Interface (114)

The Cryptographic Interface (114) is a software and/or hardware layer operating within the TEE (110) boundary, configured to securely transmit critical execution data to the Log Service (130). This interface performs secure encryption and hashing of log entries (including decision outcomes and rejected harm scores) prior to transmission, ensuring the data is correctly formatted as a leaf node for the Merkle Tree structure maintained by the Cryptographic Audit Log Service (130).

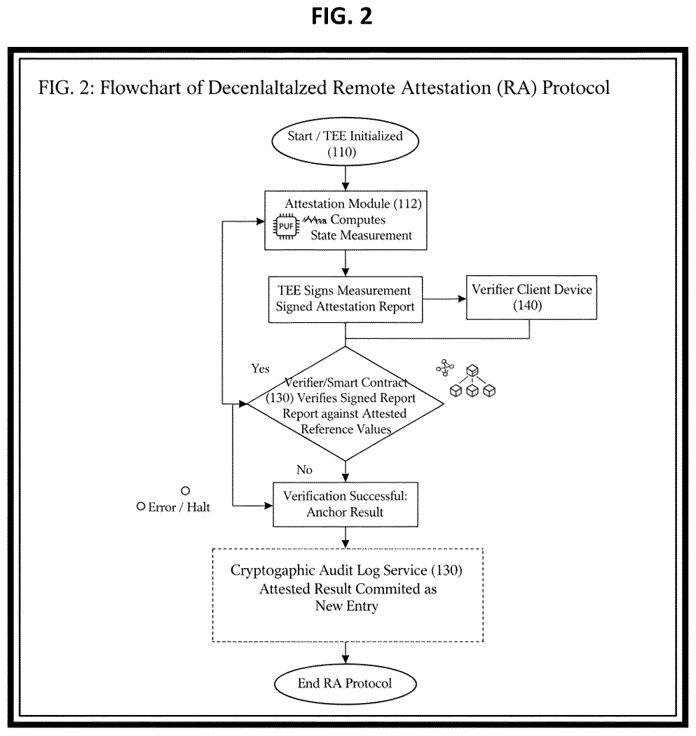

### B. Decentralized Remote Attestation (RA) Protocol (FIG. 2)

The invention utilizes an enhanced RA protocol designed to achieve decentralized trust:

### 1. Enhanced State Measurement and Signing

The process begins with the TEE (110) computing a comprehensive state measurement via the Attestation Module (112). This measurement includes not only the customary hashes of the running Trusted Application (TA) code (120) but, crucially, a measurement derived directly from the intrinsic Physically Unclonable Function (PUF). This PUF measurement acts as a decentralized, device-specific trust anchor. The TEE then uses a private key embedded in the hardware (which may itself be derived from the PUF) to cryptographically sign this detailed state measurement, generating the signed attestation report.

### 2. Decentralized Verification and Anchoring

The signed attestation report is delivered to the Verifier Client Device (140). The verification process involves standard checks, augmented by leveraging a decentralized verification mechanism, such as a smart contract running on the distributed ledger (130). This smart contract can facilitate the verification of the TEE's public key or validate the PUF-derived measurement against publicly available, attested reference values. Once verified, the attestation result is immediately anchored into the Cryptographic Audit Log Service (130) via the Cryptographic Interface (114).

### C. Hierarchical Constraint Logic Programming (HCLP) Module (120) for Ethical Governance

1. Definition and Implementation within TEE for Real-Time Arbitration

The Hierarchical Constraint Logic Processor (HCLP) (120) is implemented as the central decision engine of the EGE, operating entirely within the integrity boundary of the TEE (110). This placement ensures that the application of ethical rules and the resulting decision cannot be tampered with by the Host OS or external actors. The HCLP module extends conventional Constraint Logic Programming (CLP) by allowing for the definition and enforcement of constraint hierarchies comprising distinct levels of preference strength.

### 2. Constraint Hierarchy Schema for Ethical Decision-Making

The HCLP module (120) translates abstract ethical principles into enforceable computation by processing constraints organized into mandatory safety requirements and tiered ethical optimization goals:
Required Constraints (Hard Safety Mandates): These constraints are non-negotiable physical or regulatory boundaries that must be satisfied by all potential control maneuvers (outputs). Violation of a Required Constraint results in the immediate rejection or halting of that decision path, ensuring fundamental safety compliance. Examples include:
   Vehicle Dynamics Integrity: Enforcement that calculated control maneuvers (acceleration, braking, steering) remain within the physical stability limits (e.g., non-violation of friction ellipse thresholds, rollover thresholds).
   System Integrity Check: Halt execution if the TEE runtime integrity hash fails verification post-Remote Attestation.
Preferential Constraints (Ethical Arbitration Objectives): These constraints are used for selection and arbitration among the set of potential outcomes that successfully satisfy all Required Constraints. They implement the codified ethical framework by assigning a quantifiable “Harm Score” to each viable outcome, seeking the path that minimizes harm. The strict hierarchy is defined by the operator prior to the mission and immutably logged, such as:
   Rule 1 (Highest Preference): Prioritize preservation of human life (minimize Human Injury Likelihood Score—HILS).
Rule 2 (Second Preference): Prioritize avoiding critical infrastructure and minimizing public safety risk.
Rule 3 (Lowest Preference): Minimize financial impact (e.g., private property damage).

### 3. Enabling Example: Unavoidable Collision and Auditable Ethical Arbitration

To establish clear enablement for the EGE, the HCLP functionality is described in the context of an unavoidable collision scenario (the “trolley problem”):
Scenario Input: The autonomous perception system identifies an imminent collision and generates a dataset of potential control maneuvers (P1, P2, P3). The HCLP receives this real-time threat assessment and potential outcome dataset.
Required Constraint Check: The HCLP first checks if maneuvers P1, P2, and P3 satisfy all Required Constraints. If P3 is determined to exceed the vehicle's braking friction limit, P3 is immediately rejected as physically impossible (compliance status: failure).
Ethical Arbitration (Harm Score Assignment): The HCLP evaluates the viable options (P1 and P2) against the Preferential Constraints. P1, for example, results in collision with an unoccupied critical infrastructure asset (Harm Score=8). P2 results in collision with private property (Harm Score=2).
Auditable Decision and Execution: The HCLP selects P2 because it yields the lowest overall Harm Score (2<8). The TEE executes the command for P2. The entire decision process is immediately packaged by the Cryptographic Interface (114). The log entry captures the chosen maneuver, the specific ethical ruleset hash, and, crucially, the calculated harm score of the rejected option (P1, Score 8). This log proves the chosen maneuver was compliant with the pre-defined ethical mandate and was the result of a verifiable arbitration process.

### D. Cryptographic Audit and Log Anchoring (130)

The final critical component is ensuring that the constrained execution results are immutable and auditable.

### 1. Tamper-Evident Log Structure

The Cryptographic Audit Log Service (130) is structured to maintain a tamper-evident record utilizing a Merkle Tree structure. The Merkle Tree ensures that all log entries are append-only; records cannot be deleted, modified, or retroactively inserted, providing cryptographic assurance against tampering.

### 2. Mandated EGE Log Entry Requirements

To satisfy the regulatory mandate for non-black-box ethical arbitration, the log entries anchored as leaf nodes in the Merkle Tree must include:
The verified Decentralized Attestation Report from the TEE (110) (Initial State).
The hash of the Cryptographically Signed Ethical Ruleset used during execution.
The sensor data snapshot and threat assessment that triggered the decision event.
The complete set of potential outcomes identified, including the calculated Harm Score assigned to each viable outcome by the HCLP, and the specific ethical rules applied to generate said scores. (Crucial for regulatory auditability).
The HCLP compliance decision, specifically verification that all Required Constraints (Hard Safety Mandates) were met by the chosen execution path.
The final command executed.

The Cryptographic Interface (114) aggregates this data and transmits it to the Log Service (130).

TABLE 1
Data Element Functionality

| | | | Log |
|---|---|---|---|
| | Source | Function in | Requirement |
| Data Element | (Component) | Audit Chain | for EGE |
| Attestation Report | TEE Attestation | Verifies initial | Mandatory |
| (Initial State) | Module (112) | TEE integrity and | |
| | | code identity. | |
| Ethical Ruleset | HCLP Processor | Identifies the | Mandatory |
| Hash | (120) | certified ethical | |
| | | policy used. | |
| Rejected | HCLP Processor | Proves non-black- | Mandatory |
| Outcome Harm | (120) | box ethical | |
| Scores | | arbitration. | |
| Merkle Tree Root | Log Service (130) | Anchors all | Mandatory |
| Hash (MTRH) | | recorded events | (Output) |
| (150) | | into a single | |
| | | tamper-evident | |
| | | hash. | |

### 3. Cryptographic Audit Certificate (GAG) Function

The Log Service (130) periodically computes a Merkle Tree Root Hash (MTRH) (150). The MTRH (150) is digitally signed by the Log Service (130) to create a Signed Tree Head (STH), which functions as the Cryptographic Audit Certificate (CAC). A remote auditor (140) can verify the integrity and non-repudiation of the specific ethical decision by retrieving the CAC (150) and applying an efficient Merkle proof, ensuring the machine complied with its pre-defined ethical mandate.

What is claimed is:

1. A computer-implemented method for creating a verifiable, counterfactual audit log for autonomous decisions, the method comprising:
a. Executing, by a Hierarchical Constraint Logic Processor (HCLP) operating within a Trusted Execution Environment (TEE) established by a processing device, a constraint hierarchy to evaluate a plurality of potential control maneuvers received from an autonomous perception system, the constraint hierarchy comprising:
i. one or more Required Constraints defining non-negotiable physical safety parameters; and
ii. one or more Preferential Constraints defining prioritized ethical mandates, wherein each potential control maneuver is associated with a calculated harm score based on said Preferential Constraints;
b. applying, by the HCLP, the constraint hierarchy to generate:
i. a selected control maneuver determined to satisfy the one or more Required Constraints and having a lowest calculated harm score; and
ii. a set of rejected control maneuvers, wherein each rejected control maneuver is associated with its corresponding calculated harm score;
c. Performing, by an Attestation Module within the TEE, a decentralized remote attestation (RA) to verify an integrity of the TEE and the HCLP, the RA generating a state measurement incorporating a measurement derived from a Physically Unclonable Function (PUF) integrated with the processing device, thereby establishing an intrinsic root of trust;
d. generating, by a Cryptographic Interface operating within the TEE, a verifiable log entry that cryptographically binds:
i. the RA state measurement;
ii. a hash of the constraint hierarchy; and
iii. the calculated harm scores of the set of rejected control maneuvers; and
e. Anchoring the verifiable log entry into a tamper-evident Cryptographic Audit Log Service structured as a Merkle Tree, wherein the anchoring comprises computing a new Merkle Tree Root Hash (MTRH) based on the verifiable log entry.

2. The method of claim 1, wherein the step of applying the one or more Required Constraints enforces compliance with a predetermined limit on vehicle stability during the execution of the selected control maneuver.

3. The method of claim 1, wherein the one or more Preferential Constraints are based on the classification of potential collision objects according to a hierarchy of preservation, said hierarchy comprising human life, critical infrastructure, and private property.

4. The method of claim 1, wherein the step of performing decentralized remote attestation further comprises leveraging a smart contract running on the Cryptographic Audit Log Service to verify the RA state measurement.

5. The method of claim 1, further comprising: halting the execution of the HCLP upon determination that all potential control maneuvers violate the one or more Required Constraints.

6. The method of claim 1, wherein the anchoring further comprises digitally signing the MTRH to create a Cryptographic Audit Certificate (CAC).

7. The method of claim 6, further comprising:
a. receiving, by a remote Verifier Client Device, the CAC; and using a Merkle proof to verify the integrity of the verifiable log entry against the CAC.

8. A constrained execution system for creating a verifiable, counterfactual audit log for autonomous decisions, the system comprising:
a. one or more processors and a non-transitory memory configured to establish a Trusted Execution Environment (TEE), the TEE housing:
i. a Hierarchical Constraint Logic Processor (HCLP) configured to apply a constraint hierarchy, comprising Required Constraints governing physical safety limits and Preferential Constraints governing ethical prioritization, to a plurality of potential outputs from an autonomous system, the HCLP further configured to generate (1) a selected control maneuver and (2) a set of rejected control maneuvers with their corresponding calculated harm scores;
ii. an Attestation Module configured to generate a decentralized remote attestation (RA) state measurement to verify an integrity of the TEE and the HCLP, the state measurement utilizing an embedded Physically Unclonable Function (PUF) to provide a device-specific root of trust; and
iii. a Cryptographic Interface configured to generate a verifiable log entry that cryptographically binds the RA state measurement, a hash of the constraint hierarchy, and the calculated harm scores of the set of rejected control maneuvers; and
b. a Cryptographic Audit Log Service implemented using a distributed ledger, the Log Service communicatively coupled to the TEE and configured to:
i. receive the verifiable log entry from the Cryptographic Interface;
ii. store the verifiable log entry as a leaf in a Merkle Tree structure; and
iii. generate a Signed Tree Head (STH) based on a root hash of the Merkle Tree.

9. The system of claim 8, wherein the Attestation Module is further configured to utilize a smart contract associated with the Log Service to facilitate verification of the decentralized state measurement.

10. The system of claim 8, wherein the HCLP Processor is configured to enforce the at least one Required Constraint by validating that a potential output remains within predetermined vehicle dynamic stability limits.

11. The system of claim 8, wherein the Cryptographic Audit Log Service is configured to generate the STH to serve as a Cryptographic Audit Certificate (CAC).

12. The system of claim 8, further comprising a Verifier Client Device configured to request a Merkle proof from the Cryptographic Audit Log Service to verify the integrity of the verifiable log entry related to the constraint compliance data.

13. A non-transitory computer-readable storage medium storing instructions that, when executed by a processing system configured to establish a Trusted Execution Environment (TEE), cause the processing system to perform the method steps of claim 1.
